(19) United States
(12) Patent Application Publication
(10) Pub. No.: US 2020/0361287 A1
(43) Pub. Date: Nov. 19, 2020

(54) HEATING ARRANGMENT AND A METHOD FOR CONTROLLING THE HEATING ARRANGEMENT

(71) Applicant: Mahle International GmbH, Stuttgart (DE)

(72) Inventor: Matthias Schall, Ostfildern (DE)

(21) Appl. No.: 16/874,457

(22) Filed: May 14, 2020

(30) Foreign Application Priority Data
May 14, 2019 (DE) 102019206930.4

(51) Int. Cl. B60H 1/22; H05B 1/02; F24H 9/18

(52) U.S. Cl. CPC B60H 1/2218; B60H 1/2225; B60H 2001/2231; F24H 9/1872; H05B 1/0236

(57) ABSTRACT

The present disclosure describes to a heating arrangement for an electric vehicle and a method for controlling such a heating arrangement. The heating arrangement includes at least one PTC heater and a control device for controlling the at least one PTC heater. The control device includes an HF pulse width modulator that generates an HF modulation signal in multiple modulation steps. The respective modulation step of the HF pulse width modulator corresponds to an output step of the at least one PTC heater, so that the control device, via the HF pulse width modulator, adjusts the output of the at least one PTC heater between a minimum output and a maximum output, step-by-step, in the plural output steps.

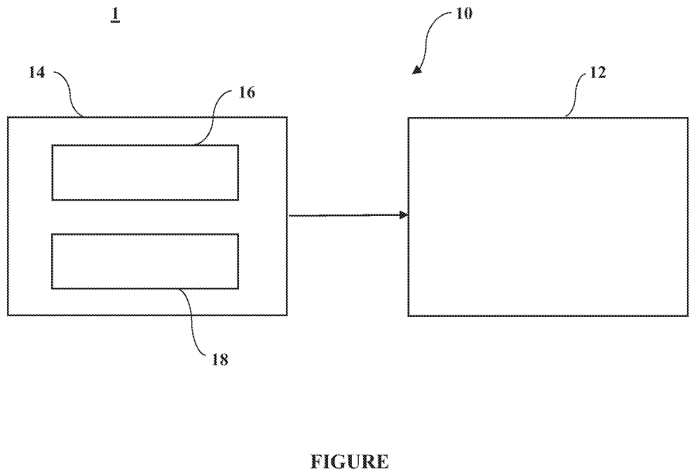

### CROSS-REFERENCE TO RELATED APPLICATION

This application claims priority to German Application No. DE 10 2019 206 930.4 filed on May 14, 2019, the contents of which are hereby incorporated by reference in its entirety.

### TECHNICAL FIELD

The invention relates to a heating arrangement for an electric vehicle having at least one PTC heater. The invention also relates to a method for controlling the heating arrangement.

### BACKGROUND

For air conditioning an electric vehicle, heating arrangements with PTC heaters (PTC: positive temperature coefficient) are employed. Since in the electric vehicle no further heat sources are present, the maximum output of such a PTC heater often amounts to more than 5 kW. The PTC heaters are mostly controlled by the electronics, which are usually directly attached to the PTC heater. Typically, the control is a PWM control (PWM: pulse width modulation), which adapts the voltage applied to the PTC heater and thereby its output by way of a modulation signal. Because of the electrical and physical properties of the PTC heater, their maximum attainable control frequency—i.e. the frequency of the modulation signal—is limited. This is usually in a three-digit hertz range.

Because of the high maximum output of the PTC heaters, the resolution of the internal vehicle communication that is usually limited to 8 bit, the limited measurement accuracy of current and voltage in the PTC heaters and the limited control frequency, the minimum output of the PTC heaters that can be adjusted is limited. Usually, the output of the PTC heater is controlled in 100 steps and the minimum output that is adjustable accordingly amounts to 1% of the maximum output. Because of this, small temperature increases—such as for example in a re-heat mode of the heating arrangement—are difficult to realize.

Since however the maximum control frequency and because of this the minimum output that is adjustable are limited by the electrical and physical properties of the PTC heaters, an increase of the resolution on the control side has its limits. With an increased resolution, the relevant electrical quantities—such as for example current and voltage—also have to be measured, furthermore, with a correspondingly increased resolution.

The object of the invention therefore is to state an improved or at least alternative embodiment for a heating arrangement of the generic type, with which the described disadvantages are overcome. The object of the invention also is to provide an improved method for controlling the heating arrangement.

According to the invention, these objects are solved through the subject of the independent claims. Advantageous embodiments are subject of the dependent claims.

### SUMMARY

The present invention is based on the general idea of utilizing the high thermal inertia or the high heat capacity of a PTC heater in a heating arrangement and reduce the minimum adjustable output through an additional low-frequency modulation. The heating arrangement added for an electric vehicle and comprises at least one PTC heater and a control device for controlling the at least one PTC heater. The control device comprises an HF pulse width modulator, by way of which an HF modulation signal is generatable in multiple modulation steps. The respective modulation step of the HF pulse width modulator corresponds to an output step of the at least one PTC heater, so that by means of the HF pulse width modulator the control device can adjust the output of the at least one PTC heater between a minimum output and a maximum output step-by-step in the multiple output steps. According to the invention, the control device comprises an LF pulse width modulator, which with an LF modulation signal can modulate the HF modulation signal between the one modulation step and the next higher or next lower modulation step, step-by-step in multiple intermediate modulation steps. The respective modulation intermediate step of the HF pulse width modulator corresponds to an output intermediate step of the at least one of the PTC heater, so that by means of the LF pulse width modulator the control device can adjust the output of the at least one PTC heater between the one output step and the next higher or next lower output step step-by-step in the multiple intermediate output steps.

The abbreviation “HF” relates to the term “high frequency” and the abbreviation “LF” relates to the term “low frequency”. In the context with the present invention, the two terms merely relate to a relative ratio between two frequencies and not to any predefined regions of these frequencies. In order to avoid confusing the terms, the elements or characteristics referred to by “HF” relate directly or indirectly to the HF pulse width modulator and the elements or characteristics referred to by “LF” directly or indirectly to the LF pulse width modulator.

The heating arrangement according to the invention, the output of the at least one PTC heater can be adjusted to the output steps and to the output intermediate steps and varied between the minimum output and the maximum output. The minimum output of the at least one PTC heater is practically equal to zero. The output in the respective output step differs from the output in the respective output intermediate step. The minimum adjustable output of the at least one PTC heater corresponds to a difference in the output between two adjacent output intermediate steps and is at least two times smaller than the difference in the output between two adjacent output steps. Thus, the output of the at least one PTC heater is far more accurately controllable. In particular in a re-heat mode of the heating arrangement, small temperature increases can thus be better realized because of this. The control-side resolution advantageously remains the same.

Advantageously, an LF time frame of the LF modulation signal can be adjusted dependent on the thermal inertia of the at least one PTC heater. An LF time frame of the LF modulation signal can advantageously amount to under 20 seconds. Here, the LF time frame with the higher thermal inertia or the higher heat capacity of the at least one PTC heater can also be correspondingly high. An LF frequency of the LF modulation signal can be for example under 10 hertz. In order to improve the temperature stability of the PTC heater, the LF modulation signal can be divided by the LF pulse width modulator within an LF time frame over multiple individual LF activation signals. Here, the LF duty cycle of the LF modulation signal to be adjusted remains constant regardless of the number of the LF activation signals. Alternatively or additionally, the HF modulation signal can be divided by the HF pulse width modulator over multiple individual HF activation signals within an HF time frame. Here, too, the HF duty cycle of the HF modulation signal remains constant regardless of the number of the HF activation signals. Advantageously it can also be provided that the HF pulse width modulator and the LF pulse width modulator are embodied by a single control unit of the control device. In particular, the conventional control unit of the control device with the HF pulse width modulator can be additionally programmed as LF pulse width modulator. Alternatively it can be provided that the LF pulse width modulator is embodied by a separate control unit, which is for example a part of a control on the motor vehicle side. Advantageously, an existing or already installed heating arrangement can then be quasi retrofitted in that the separate control unit is installed or however the existing control on the motor vehicle side is suitably programmed.

### BRIEF DESCRIPTION OF THE DRAWINGS

The FIGURE shows a diagrammatic representation of a heating arrangement of an electric vehicle according to an exemplary illustration.

### DETAILED DESCRIPTION

The FIGURE shows a diagrammatic representation of a heating arrangement 10 of an electric vehicle 1 including at least one PTC heater 12 and a control device 14 for controlling the at least one PTC heater 12, the control device 14 including an HF pulse width modulator 16 and an LF pulse width modulator 18.

In the following, multiple individual numerical examples are stated to illustrate the inventive idea. It is to be understood that the values mentioned and the mentioned ranges are merely exemplary and have no restrictive effect.

The HF modulation signal is generatable in multiple modulation steps. The number of the modulation steps depends on the HF frequency and the HF time frame of the HF modulation signal. The respective modulation steps differ from one another by the HF duty cycle, which then pre-sets the output of at least one PTC heater in the respective set modulation step. In other words, the respective output steps of the at least one PTC heater differ by the HF duty cycle of the HF modulation signal in the respective modulation step. When there is a proportional relationship between the applied voltage and the generated output of the at least one PTC heater, the HF duty cycle in the respective modulation step is then equal to a ratio between the current output and the maximum output of the at least one PTC heater. When the HF duty cycle for example is equal to zero, the current output and accordingly the ratio between the current output and the maximum output of the at least one PTC heater is also equal to zero. When the HF duty cycle is for example equal to 0.5, the ratio between the current output and the maximum output of the at least one PTC heater is also equal to 0.5. The current output then amounts to 50% of the maximum output of the at least one PTC heater.

The LF modulation signal modulates the HF modulation signal into the multiple intermediate modulation steps in that the HF modulation signal is high-frequency connected between the one modulation step and the next higher or next lower modulation step. In the same way, the LF modulation signal can be generated in multiple—but at least in three—switching steps, wherein the switching steps differ from one another by the LF duty cycle. The LF modulation signal can be for example a square wave signal. Alternatively, the LF modulation signal can be a pure on/off signal (0/1 signal). The pure on/off signal then pre-sets a duration of the deactivation phase and a duration of the activation phase. In the deactivation phase, the HF modulation signal is modulated to the one modulation step and the at least one PTC heater is operated on the corresponding output step. In the activation phase, the HF modulation signal is then modulated to the next higher or next lower modulation step and the at least one PTC heater is operated on the corresponding next higher or next lower output step. A time frame of the LF modulation signal then corresponds to the sum of the two durations. The LF duty cycle mentioned above is then determined by the ratio between the duration of the activation phase and of the time frame.

With the minimum number of the switching steps, the adjustable LF duty cycle for example amounts to 0, 0.5 and 1. With the LF duty cycle equal to 0, the HF modulation signal is modulated to the one modulation step and with the LF duty cycle equal to 1, to the next higher modulation step. At the LF duty cycle equal to ½, the modulation intermediate step of the HF modulation signal is then present at which the HF modulation signal is low-frequency switched between the two modulation steps following one another. In other words, the HF duty cycle of the HF modulation signal is low-frequency modulated by the LF modulation signal to an intermediate value which the non-modulated HF modulation signal cannot accept. This HF duty cycle of the modulated HF modulation signal then corresponds to the modulation intermediate step which in turn corresponds to the output intermediate step of the at least one PTC heater. In the output intermediate step, the at least one PTC heater is low-frequency switched between the adjacent output steps, wherein because of the thermal inertia or the heat capacity of the at least one PTC heater, a mean output is output. This mean output then corresponds to the output of the PTC heater in the respective output intermediate step.

The invention also relates to a method for controlling the heating arrangement described above. Here, the HF pulse width modulator of the control device generates the HF modulation signal in the multiple modulation steps, wherein the respective modulations corresponds to the respective output step of the at least one PTC heater. Because of this, the control device, by means of the HF pulse width modulator, adjusts the output of the at least one PTC heater between the minimum output and the maximum output step-by-step in the multiple output steps. With the LF modulation signal the LF pulse width modulator of the control device modulates the HF modulation signal step-by-step between the one modulation step and the next higher or next lower modulation step in the multiple intermediate modulation steps. Here, the respective modulation intermediate step corresponds to the respective output intermediate step of the at least one PTC heater, so that the control device, by means of the LF pulse width modulator, adjusts the output of the PTC heater between the one output step and the next higher or next lower output step, step-by-step in the multiple intermediate output steps.

Advantageously, the LF pulse modulator can modulate the HF modulation signal in an LF time frame under 20 seconds and/or with an LF frequency under 10 hertz. In order to increase the temperature stability of the at least one PTC heater, the LF pulse width modulator can divide the LF modulation signal within an LF time frame over multiple individual LF activation signals and/or the HF width modulator can divide the HF modulation signal within an HF time frame over multiple individual HF activation signals. The HF pulse width modulator can advantageously modulate the at least one PTC heater with an HF frequency above 30 hertz.

In order to avoid repetitions, reference is expressly made here to the above description regarding the heating arrangement according to the invention.

For illustrating the inventive idea a numerical example is now given. It is to be understood that the mentioned values and the mentioned ranges are merely exemplary and have no restrictive effect. The PTC heater with a maximum output of for example 10 kW is considered, which is controllable step-by-step with the HF modulation signal with multiple modulation steps. For example, the time frame of the HF modulation signal can amount to 1 second and the HF frequency of the HF modulation signal to 100 hertz. With the HF modulation signal, the output of the PTC heater can be adjusted between the minimum output and the maximum output for example in a total of 100 steps with the minimum adjustable output equal to 1% of the maximum output or 100 watt. The LF modulation signal for example has the LF frequency of 1 hertz and the LF time frame amounts to 4 seconds. By way of the LF modulation, the HF modulation signal is modulated step-by-step for example between the 000 modulation step and the next higher 001 modulation step. In the 000 modulation step, the HF duty cycle and the output of the PTC heater are equal to zero. In the next higher 001 modulation step, the HF duty cycle is equal to 0.01 and the output of the PTC heater amounts to 1% of the maximum output or 100 watt. This also corresponds to the minimum adjustable output of the PTC heater with the non-modulated HF modulation signal.

With the LF duty cycle of the LF modulation signal equal to 0.25, the PTC heater is operated for 3 seconds at the 000 modulation step and 1 second at the next higher 001 modulation step. In other words, the PTC heater is operated for 3 seconds at 0% output and for 1 second at 1% output. Viewed integrally over the LF time frame of 4 seconds, a 0.25 modulation intermediate step is obtained, at which the HF duty cycle of the modulated HF modulation signal is at 0.0025. This HF duty cycle cannot be achieved with the non-modulated HF modulation signal. The HF duty cycle of the modulated HF modulation signal in the 0.25 modulation intermediate step corresponds to the output intermediate step of the PTC heater, at which the resultant output because of the high thermal inertia or the high heat capacity of the PTC heater is averaged from 0% output and from the 1% output. Here, this corresponds to the sum of 0.75 times output at the 000 modulation step and 0.25 times output at the 001 modulation step or however the product between the resultant HF duty cycle of the modulated HF modulation signal of 0.0025 and the maximum output of the PTC heater. The resultant output of the PTC heater at the adjusted output intermediate step consequently amounts to 25 watt.

With the LF duty cycle of the LF modulation signal equal to 0.5, the PTC heater is then operated for 2 seconds at the 000 modulation step and for 2 seconds at the 001 modulation step. In other words, the PTC heater is operated for 2 seconds at 0% output and for 2 seconds at 1% output. Here, the LF modulation signal can be divided into an LF activation signal of 2 seconds or however into two LF activation signals of 1 second each. Viewed integrally over the LF time frame of 4 seconds, a 0.5 modulation intermediate step is obtained, at which the HF duty cycle of the modulated HF modulation signal is at 0.005. With the non-modulated HF modulation signal, this HF duty cycle cannot be achieved. The HF duty cycle of the modulated HF modulation signal in the adjusted 0.5 modulation intermediate step corresponds to the output intermediate step of the PTC heater, at which the resultant output, because of the high thermal inertia or the high heat capacity of the PTC heater, is averaged from 0% output and from 1% output. Here, this corresponds to the sum of the 0.5 times output at the 000 modulation step and 0.5 times output at the 001 modulation step or however to the product between the resultant HF duty cycle of the modulated HF modulation signal of 0.005 and the maximum output of the PTC heater. The output of the PTC heater at the output intermediate step adjusted here consequently amounts to 50 watt.

With the LF duty cycle of the LF modulation signal equal to 0.75, the PTC heater is operated for 1 second at the 000 modulation step and for 3 seconds at the 001 modulation step. In other words, the PTC heater is operated for 1 second at the 0% output and for 3 seconds at the 1% output. Viewed integrally over the LF time frame of 4 seconds, this results in a 0.75 modulation intermediate step, at which the HF duty cycle of the modulated HF modulation signal is at 0.0075. With the non-modulated HF modulation signal, this HF duty cycle cannot be achieved. The HF duty cycle of the modulated HF modulation signal in the 0.75 modulation intermediate step corresponds to the output intermediate step of the PTC heater, at which the resultant output, because of the high thermal inertia or the high heat capacity of the PTC heater, is averaged from 0% output and from the 1% output. Here, this corresponds to the sum of the 0.25 times output at the 000 modulation step and the 0.75 times output at the 001 modulation step or however the product between the resultant HF duty cycle of the modulated HF modulation signal of 0.0075 and the maximum output. The output of the PTC heater at the adjusted output intermediate step consequently amounts to 75 watt.

According to this numerical example, the PTC heater can be controlled with the modulated HF modulation signal in 000 modulation step, in 0.25 modulation intermediate step, in 0.5 modulation intermediate step, in 0.75 modulation intermediate step or in 001 modulation step and because of this operated with 0 watt, with 25 watt, with 50 watt, with 75 watt or with 100 watt. Compared with the non-modulated HF modulation signal, the minimum adjustable output has thus been reduced from 100 watt to 25 watt. In the same way, the HF modulation signal can also be modulated step-by-step between two random adjacent modulation steps and the PTC heater correspondingly operated in the output intermediate steps. When for example the HF modulation signal is modulated between 025 modulation step and 026 modulation step by the LF modulation signal, 25, 25 modulation intermediate step can be adjusted with the HF duty cycle equal to 0.2525 and the resultant output of 25.25% of the maximum output or 25 25 watt; 25.5 modulation intermediate step with the HF duty cycle equal to 0.255 and the resultant output of 25.5% of the maximum output or 2550 watt and 25.75 modulation intermediate step with the HF duty cycle equal to 0.2575 and the resultant output of 25.75% of the maximum output or 2575 watt.

In the PTC heater according to this numerical example, three output intermediate steps can be adjusted between each two adjacent output steps. Because of this, the minimum adjustable output of 100 watt can be reduced to 25 watt and the PTC heater controlled far more precisely. Here, the HF modulation signal is low-frequency modulated with the LF modulation signal and the control-side resolution need not be increased. This cannot be achieved in a conventional manner with a non-modulated HF modulation signal.

1. A heating arrangement for an electric vehicle, comprising:
at least one PTC heater and a control device for controlling the at least one PTC heater,
the control device including an HF pulse width modulator, structured and arranged to provide an HF modulation signal in plural modulation steps can be generated,
wherein a respective modulation step of the HF pulse width modulator corresponds to an output step of plural output steps of the at least one PTC heater, so that the control device, via the HF pulse width modulator, can adjust, step-by-step an output of the at least one PTC heater between a minimum output and a maximum output in the plural output steps,
the control device further including an LF pulse width modulator, structured and arranged to modulate the HF modulation signal with an LF modulation signal between the respective modulation step and the next higher or next lower modulation step, step-by-step in plural intermediate modulation steps, and
wherein a respective intermediate modulation step of the HF pulse width modulator corresponds to an intermediate output step of plural intermediate output steps of the at least one PTC heater, so that the control device, via the LF pulse width modulator can adjust the output of the at least one PTC heater between a respective output step and the next higher or next lower output step, step-by-step, in the plural intermediate output steps.

2. The heating arrangement according to claim 1, wherein an LF time frame of the LF modulation signal amounts to under 20 seconds.

3. The heating arrangement according to claim 1, wherein an LF time frame of the LF modulation signal is adjusted dependent on a thermal inertia of the at least one PTC heater.

4. The heating arrangement according to claim 1, wherein an LF frequency of the LF modulation signal is under 10 hertz.

5. The heating arrangement according to claim 1, wherein the LF modulation signal of the LF pulse width modulator within an LF time frame is divided over a plurality of individual LF activation signals.

6. The heating arrangement according to claim 1, wherein:
the HF pulse width modulator and the LF pulse width modulator are provided by a single control unit of the control device, or
the LF pulse width modulator is provided by a separate control unit in the control device.

7. A method for controlling a heating arrangement, comprising:
providing at least one PTC heater and a control device for controlling the at least one PTC heater, the control device including an HF pulse width modulator and an LF pulse width modulator,
generating via the HF pulse width modulator of the control device an HF modulation signal in plural modulation steps, wherein a respective modulation step corresponds to a respective output step of plural output steps of the at least one PTC heater such that the control device, via the HF pulse width modulator, adjusts an output of the at least one PTC heater step-by-step between a minimum output and a maximum output in the plural output steps, and
modulating, via the LF pulse width modulator of the control device with the LF modulation signal, the HF modulation signal between the respective modulation step and the following modulation steps step-by-step in plural intermediate modulation steps, wherein a respective intermediate modulation step corresponds to a respective intermediate output step of plural intermediate output steps of the at least one PTC heater, such that the control device, via the LF pulse width modulator, adjusts the output of the PTC heater between the respective intermediate output step and the next higher or next lower intermediate output step, step-by-step, in the plural intermediate output steps.

8. The method according to claim 7, wherein the LF pulse width modulator modulates the HF modulation signal in an LF time frame under 20 seconds.

9. The method according to claim 7, wherein the LF pulse width modulator modulates the HF modulation signal with an LF frequency under 10 hertz.

10. The method according to claim 7, wherein the LF pulse width modulator divides the LF modulation signal within an LF time frame over a plurality of individual LF activation signals.

11. The method according to claim 7, wherein the HF pulse width modulator modulates the output of the at least one PTC heater with an HF frequency above 30 hertz.

12. The method according to claim 7, wherein an LF time frame of the LF modulation signal is adjusted dependent on a thermal inertia of the at least one PCT heater.

13. The method according to claim 8, wherein the LF pulse width modulator modulates the HF modulation signal with an LF frequency of under 10 hertz.

14. The method according to claim 8, wherein the LF pulse width modulator divides the LF modulation signal within the LF time frame over a plurality of individual LF activation signals.

15. The method according to claim 8, wherein the HF pulse width modulator modulates the output of the at least one PTC heater with an HF frequency of above 30 hertz.

16. The method according to claim 8, wherein the LF time frame of the LF modulation signal is adjusted dependent on a thermal inertia of the at least one PCT heater.

17. The method according to claim 10, wherein the HF pulse width modulator modulates the output of the at least one PTC heater with an HF frequency above 30 hertz.

18. The heating arrangement according to claim 2, wherein the LF time frame of the LF modulation signal is adjusted dependent on a thermal inertia of the at least one PTC heater.

19. The heating arrangement according to claim 2, wherein the LF modulation signal of the LF pulse width modulator within the LF time frame is divided over a plurality of individual LF activation signals.

20. The heating arrangement according to claim 3, wherein an LF frequency of the LF modulation signal is under 10 hertz.
